(19) United States
(12) Patent Application Publication
(10) Pub. No.: US 2010/0141640 A1
(43) Pub. Date: Jun. 10, 2010

(54) DISPLAY DEVICE AND AGING METHOD

(75) Inventor: Masamitsu FURUIE, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; CANNON KABUSHIKI KAISHA

(21) Appl. No.: 12/632,921

(22) Filed: Dec. 8, 2009

(30) Foreign Application Priority Data
Dec. 8, 2008 (JP) 2008-312346

(51) Int. Cl. G06F 3/038; G09G 5/10

(52) U.S. Cl. 345/213; 345/690

(57) ABSTRACT

The display device according to the present invention is provided with a thin film transistor (first transistor) for aging which directly connects an organic EL element to a power supply line, and furthermore, an aging control line and a thin film transistor (second transistor) for switching aging control signals are provided in order to control the thin film transistor for aging, and thus the aging period is shorter.

### CROSS-REFERENCE TO RELATED APPLICATION

The present application claims priority over Japanese Application JP2008-312348 filed on Dec. 8, 2008, the contents of which are hereby incorporated into this application by reference.

### BACKGROUND OF THE INVENTION

(1) Field of the Invention

The present invention relates to a display device and an aging method, and in particular, to an aging method for an active matrix type display device using organic electroluminescent elements as light emitting elements.

(2) Description of the Related Art

Organic EL display devices with an active matrix using organic electroluminescent elements (hereinafter referred to as organic EL elements) as light emitting elements are expected to become next-generation flat panel displays.

In such active matrix type organic EL display devices, wires for transmitting a video voltage and current are wired in a matrix and a pixel circuit formed of a thin film transistor (hereinafter referred to as TFT), which is an active element, is built-in in each pixel, in addition to an organic EL element. The brightness of light emitted by the organic EL elements is adjusted by controlling the current supplied to the organic EL elements by the pixel circuits.

As for the pixel circuits for organic EL display devices, capacitor direct connection type pixels circuits where capacitor elements for holding a video voltage are connected to signal wires (JP2003-122301A) and capacitor separation type pixel circuits where capacitor elements are separated from signal wires by switching transistors (JP2008-40326A) are known.

### SUMMARY OF THE INVENTION

Capacitor direct connection type pixel circuits do not require a switch element between signal wires and capacitor elements, and therefore, the number of TFT's is generally small, and thus, there is an advantage, such that the pixel circuits can be made compact. However, as shown in FIG. 1, each one-frame period (FLAM) is divided into a write-in period (T-DW) for writing in a video voltage in one display line unit and a light emitting (turning on) period (T-LU) for displaying an image.

Meanwhile, organic EL display devices require aging.

In organic EL display devices having a capacitor direct connection type pixel circuit, no write-in period (T-DW) is required, because no image is displayed during aging, and thus, as shown in FIG. 2B, it is possible to make the entire one-frame period (FLAM) a light emitting period (T-LU).

In conventional organic EL display devices having a capacitor direct connection type pixel circuit, however, an image voltage of the maximum level is written into one display line unit during the write-in period (T-DW), as shown in FIG. 2A, so that the organic EL display device ages while emitting light at the maximum brightness during the light emitting period (T-LU), and thus, there is a problem, such that the aging period becomes long.

The present invention is provided in order to solve the above described problems with the prior art, and an object of the present invention is to provide a technology that makes it possible to shorten the aging period in display devices and aging methods.

The above described and other objects, as well as novel features, of the present invention will become clearer from the description in the present specification and the accompanying drawings.

One typical invention from among the inventions described in the present application is briefly described below.

In order to achieve the above described object, the present invention is characterized in that a thin film transistor (first transistor) for aging which directly connects an organic EL element to a power supply line, and furthermore, an aging control line and a thin film transistor (second transistor) for switching aging control signals (second transistor) is provided for controlling the thin film transistor for aging.

During aging, the thin film transistor for switching aging control signals (second transistor) is turned on, so that a drive voltage for turning on the thin film transistor for aging is supplied to an aging control line, and the thin film transistor for aging is also turned on, and thus, the power supply line and the organic EL element are directly connected, and a current is supplied from the power supply line to an organic EL element for aging.

In addition, the thin film transistor (second transistor) for switching aging control signals is turned off and the thin film transistor for aging also turned off during normal operation, so that the organic EL element is detached from the power supply line and power is supplied to the organic EL element via the thin film transistor for driving the pixel, and thus, an image is displayed.

The effects of the typical invention from among the inventions disclosed in the present specification are briefly described below.

The display device and aging method according to the present invention make it possible to shorten the aging period.

### BRIEF DESCRIPTION OF THE DRAWINGS

FIG. 1 is a graph showing the write-in period and the light emitting (turning on) period in an organic EL display device having a capacitor direct connection type pixel circuit;

FIGS. 2A and 2B are graphs showing a conventional aging method in an organic EL display device having a capacitor direct connection type pixel circuit;

FIG. 3 is a circuit diagram showing one pixel in the organic EL display panel according to the first embodiment of the present invention, and an equivalent circuit in a peripheral portion;

FIG. 4 is a diagram for illustrating the operation of the organic EL display device according to the first embodiment of the present invention during aging;

FIG. 5 is a diagram for illustrating normal operation of the organic EL display device according to the first embodiment of the present invention;

FIGS. 6A and 6B are diagrams illustrating the aging method for the organic EL display device according to the second embodiment of the present invention;

FIGS. 7 and 7B are diagrams illustrating a terminal portion formed in the peripheral portion of the organic EL display panel;

FIG. 8 is a diagram illustrating the aging method for the organic EL display device according to the third embodiment of the present invention;

FIG. 9 is a circuit diagram showing the equivalent circuit of one pixel in the organic EL display panel according to the fourth embodiment of the present invention;

FIG. 10 is a diagram illustrating the aging method for the organic EL display device according to the fifth embodiment of the present invention; and

FIG. 11 is a circuit diagram showing the equivalent circuit of one pixel in a capacitor separation type pixel circuit to which the present invention is applied.

### DETAILED DESCRIPTION OF THE INVENTION

In the following, the embodiments of the present invention are described in detail in reference to the drawings.

Here, the same symbols are used for components having the same function in all of the drawings for illustrating the embodiments, and the descriptions thereof are not repeated.

### First Embodiment

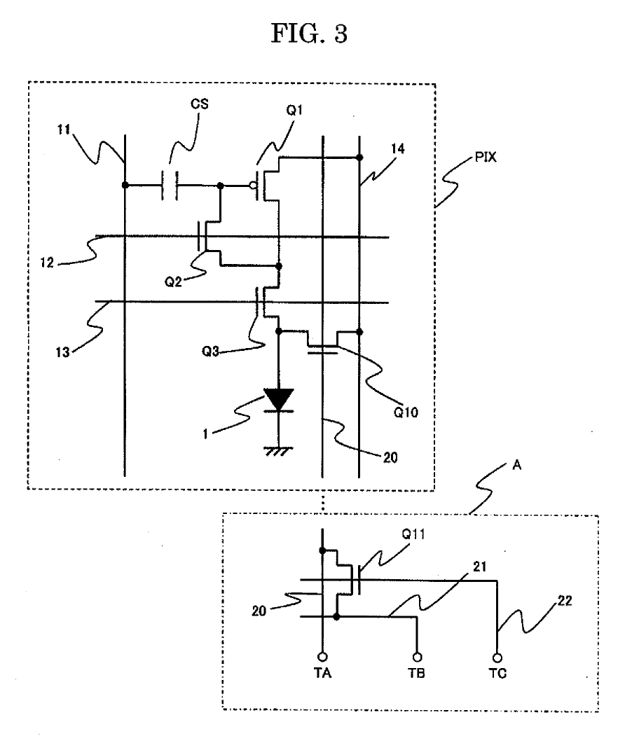

FIG. 3 is a circuit diagram showing one pixel in the organic EL display panel according to the first embodiment of the present invention, and an equivalent circuit in the peripheral portion.

A number of pixels (PIX) are provided in a matrix within the display region on the organic EL display panel of the organic EL display device according to the present embodiment. A signal line 11, a reset line 12, a turn on switch line 13, a power supply line 14 and an aging control line 20 are connected to each pixel (PIX). The signal line 11, the reset line 12 and the turn on switch line 13 are connected to the below described drive circuit (DRV).

The drive circuit (DRV) supplies a drive voltage to the reset line 12 and the turn on switch line 13 and selects a display line. In addition, the drive circuit DRV converts digital video data supplied from outside the organic EL display panel to an analog video voltage in series, which is then supplied to the signal line 11.

All of the circuits; that is, all of the pixels and all of the drive circuits, are formed on a glass substrate (GLAS) using a low temperature polycrystal silicon thin film that is generally well-known. In addition, though a great number of pixels (PIX) are actually aligned within the display region on the organic EL display panel, FIG. 3 shows only one pixel in order to make the drawing simpler. As for the resolution of the screen, in the case of color VGA, there are three columns having 640 pixels each and the number of rows is 480.

In addition, the pixels (PIX) are wired with a common ground line, not shown in the drawings.

Each pixel (PIX) has an organic electroluminescent element (hereinafter referred to as organic EL element) 1 as a light emitting element, and the cathode electrode of the organic EL element 1 is connected to a common electrode. In addition, the anode electrode is connected to a power supply line 14 via an n type thin film transistor for turning on (hereinafter referred to as turning on TFT) (Q3) and a p type thin film transistor (hereinafter referred to as drive TFT) (Q1).

The source electrode of the drive TFT (Q1) is connected to a power supply line 14, which is shared by all of the pixels (PIX). In addition, the gate electrode of the drive TFT (Q1) is connected to one of the signal lines 11 via a capacitor element (holding capacitor) (CS), and an n type thin film transistor for resetting (hereinafter referred to as reset switch) (Q2) is provided between the drain electrode and the gate electrode of the drive TFT (Q1). Here, the gate electrode of the reset switch (Q2) is connected to one of the reset lines 12. In addition, the gate electrode of the turning on TFT (Q3) is connected to one of the turning on switch lines 13.

Here, the drive TFT (Q1), the reset switch (Q2) and the turning on TFT (Q3) are all formed on a glass substrate using polycrystal silicon thin film transistors, where polysilicon is used for the semiconductor layers. Here, the method for manufacturing the polycrystal silicon thin film transistors and the organic EL element 1 is not greatly different from those generally known, and therefore, the descriptions thereof are omitted.

In the present embodiment also, one frame period that is set 1/60 seconds in advance is divided in two: a “write-in period” and a “light emitting period.”

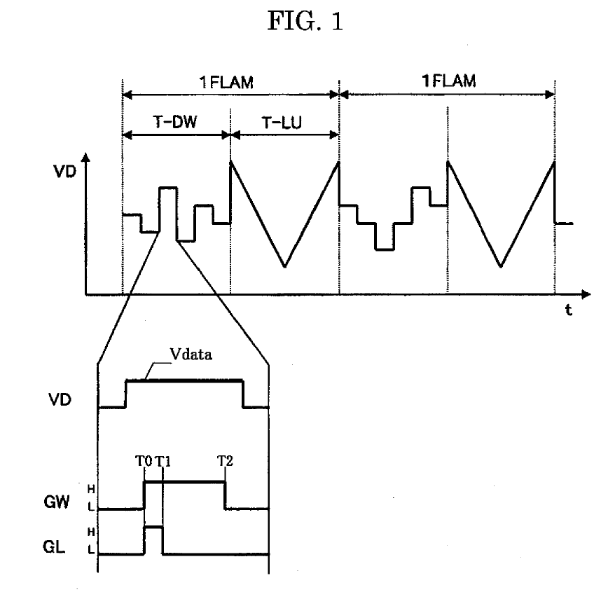

In the following, write-in of a video voltage in each pixel (PIX) and the light emitting operation of the present embodiment are described in reference to the above FIG. 1.

In FIG. 1, VD is a video voltage supplied to the signal line 11, GW is a drive voltage supplied to the reset line 12, and GL is a drive voltage supplied to the turning on switch line 13. In the following, the write-in period and the light emitting period are described.

[Write-in Period]

At the time of write-in, an analog video voltage (Vdata) is supplied from the drive circuit DRV to the signal line 11 as a video voltage (VD).

Next, when the drive voltage (GW) and the drive voltage (GL) become of a high level (hereinafter referred to as H level) at time T0, the reset switch (Q2) and the turning on TFT (Q3) are turned on. As a result, the drive TFT (Q1) provides a diode connection through which the gate electrode and the drain electrode are connected, and the voltage of the gate electrode of the drive TFT (Q1) stored in the capacitor element (CS) in the previous frame is cleared.

Next, when the drive voltage (GL) becomes of a low level (hereinafter referred to as L level) at time T1, the turning on TFT (Q3) is turned off. As a result, the drive TFT (Q1) and the organic EL element 1 are forcibly made of such a state that the current is cut off, and at this time, the gate electrode and the drain electrode of the drive TFT (Q1) are connected through the reset switch (Q2), and therefore, the voltage of the gate electrode of the rive TFT (Q1), which is also one end of the capacitor element (CS) is automatically reset to a voltage that is lower than the voltage of the power supply line 14 by the threshold voltage (Vth).

Next, when the drive voltage (GW) becomes of the L level at time T2, the reset switch (Q2) is turned off, and the difference in potential between the two ends of the capacitor element (CS) is stored in the capacitor element (CS) as it is.

At this time, when the voltage value inputted in the capacitor element (CS) on the signal line side is higher than the analog video voltage Vdata, the drive TFT (Q1) is in an off state, while when the voltage value inputted in the capacitor element (CS) on the signal line 11 side is lower than the analog video voltage Vdata, the drive TFT (Q1) becomes of an on state.

Here, the turning on TFT (Q3) of the pixel (PIX) is always in an off state during the period when a pixel (PIX) on the display line in another row is being scanned, and therefore, the organic EL element 1 is not turned on, whether the analog video voltage of the signal line 11 is high or low.

Here, write-in of an analog video voltage for pixels is carried out one row at a time in sequence, as described above, and at the point in time when write-in is completed for all of the pixels, the “write-in” in one frame is completed.

[Light Emitting Period]

During the “light emitting period” in one frame, the drive voltage (GW) is at the L level and the drive voltage (GL) is at the H level, and therefore, the turning on TFT's (Q3) of all of the elements become of an on state at the same time. At this time, a triangular wave voltage is inputted into the signal line 11.

Here, the turning on TFT's (Q3) are always in an on state, and therefore, the organic EL element 1 in each pixel (PIX) is driven by the drive TFT (Q) in accordance with the relationship between the analog video voltage Vdata which is written in in advance and the triangular wave voltage supplied to the signal line 11.

[Aging Method]

The present embodiment is characterized in that an n type thin film transistor for aging (hereinafter referred to as first transistor) (Q10) and an aging control line 20 are provided within the pixel (PIX).

In the first transistor (Q10), the source electrode (or drain electrode) is connected to the anode electrode of the organic EL element 1 and the drain electrode (or source electrode) is connected to the power supply line 14. In addition, the gate electrode of the first transistor (Q10) is connected to the aging control line 20.

Meanwhile, in the peripheral portion of the organic EL display panel (region shown by arrow A in FIG. 3), one end (TA) of the aging control line 20 is connected to one of the output terminals of the drive circuit (DRV) so that an aging control signal (S-CE) at an L level is inputted during normal operation, and the terminal is in a floating state during aging.

In addition, the source electrode (or drain electrode) of an n type tin film transistor for switching aging control signals (hereinafter referred to as second transistor) (Q11) is connected to the aging control line 20.

Furthermore, the drain electrode (or source electrode) of the second transistor (Q11) is connected to the aging control signal line 21 and the gate electrode of the second transistor (Q11) is connected to the aging control signal switching signal line 22.

In the following, the aging method of the present embodiment is described. Here, in the present embodiment, aging is carried out before the drive circuit (DRV) is mounted.

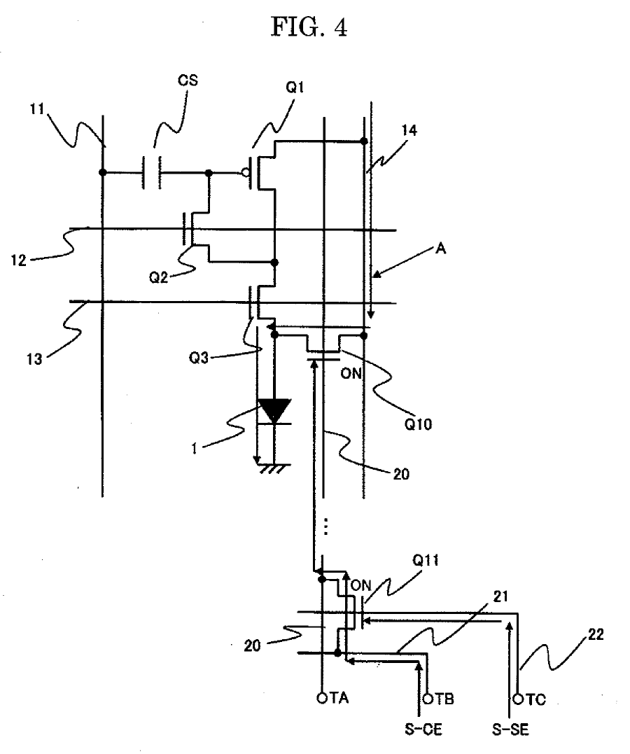

In the present embodiment, an aging control switching signal (S-SE) at an H level is inputted at one end (TC) of the aging control signal switching signal line 22 during aging. As a result, as shown in FIG. 4, the second transistor (Q11) is turned on.

In addition, an aging control signal (S-CE) at an H level is inputted at one end (TB) of the aging control signal line 21 during aging. Accordingly, the aging control signal (S-CE) at an H level is inputted into the gate electrode of the first transistor (Q10) via the second transistor (Q11), and thus, the first transistor (Q10) is turned on.

As a result, as shown by arrow A in FIG. 4, a current is supplied from the power supply line 14 to the organic EL element 1 via the first transistor (Q10).

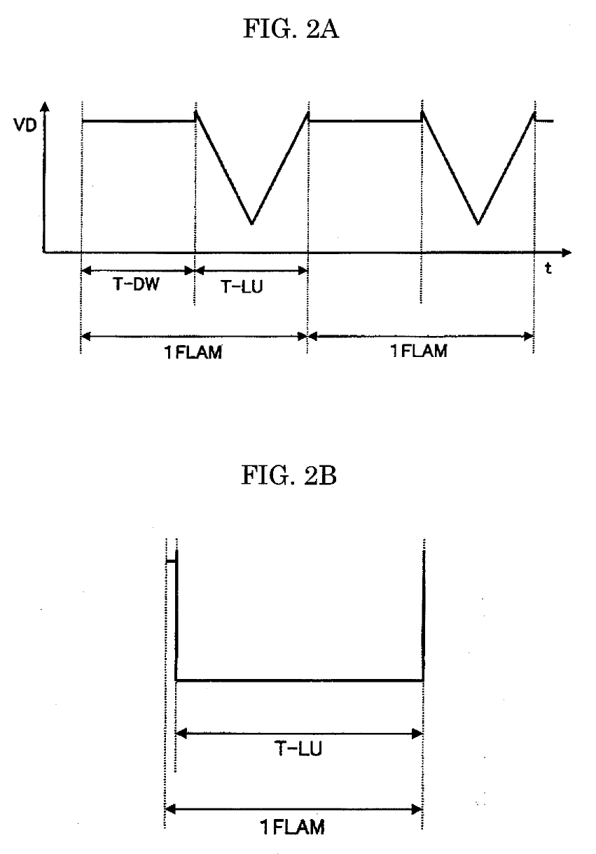

Accordingly, as shown in FIG. 2B, aging can be carried out over the entire period in one frame (FLAM), and thus, it is possible to shorten the aging period.

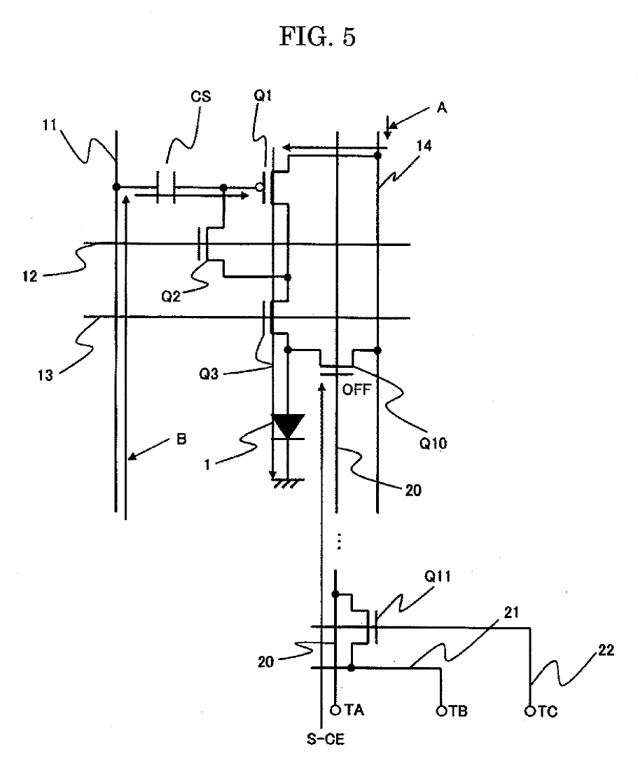

In addition, an aging control signal (S-CE) at an L level is inputted from the drive circuit (DRV) at one end (TA) of the aging control line 20 during normal operation after the drive circuit (DRV) formed of a semiconductor chip is mounted in accordance with a COG (chip on glass) method. Accordingly, as shown in FIG. 5, the first transistor (Q10) is turned off. In this case, one end (TB) of the aging control signal line 21 and one end (TC) of the aging control signal switching signal line 22 are in a floating state.

In addition, a current flows from the power supply line 14 through the organic EL element 1 via the drive TFT (Q1), as shown by arrow A in FIG. 5, on the basis of the video voltage that is written in during the write-in period (T-DW), as shown by arrow B in FIG. 5, so that an image is displayed.

### Second Embodiment

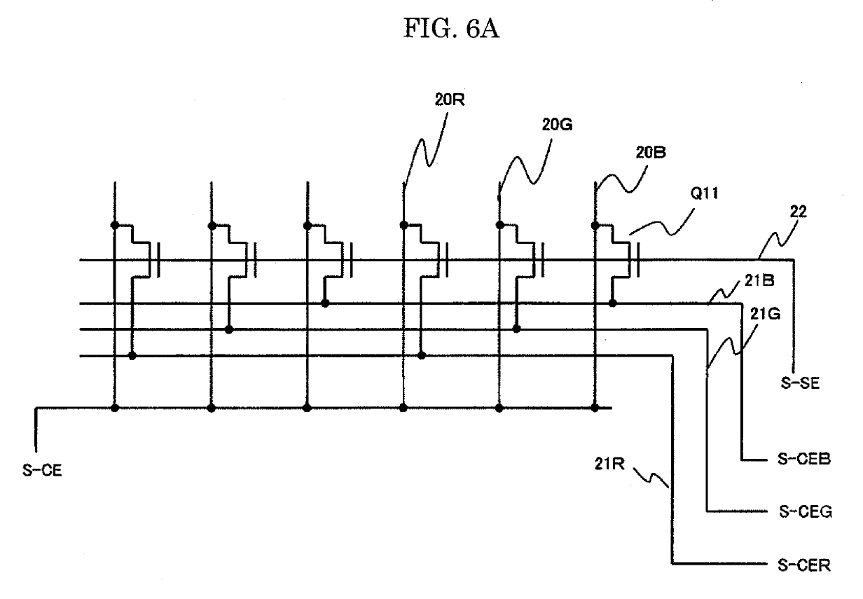

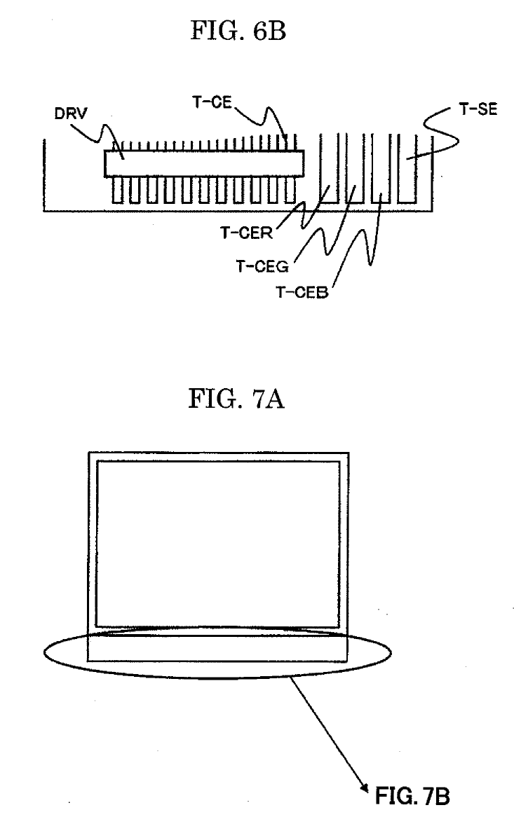

FIGS. 6A and 6B are diagrams illustrating the aging method for an organic EL display device according to the second embodiment of the present invention.

In some cases, the organic EL element 1 has different optimal aging conditions for light of different colors: R (red), G (green) and B (blue).

In the present embodiment, as shown in FIG. 6A, the aging control signal (S-CE) is divided for each color: R, G and B, so that each can be aged for the optimal aging time.

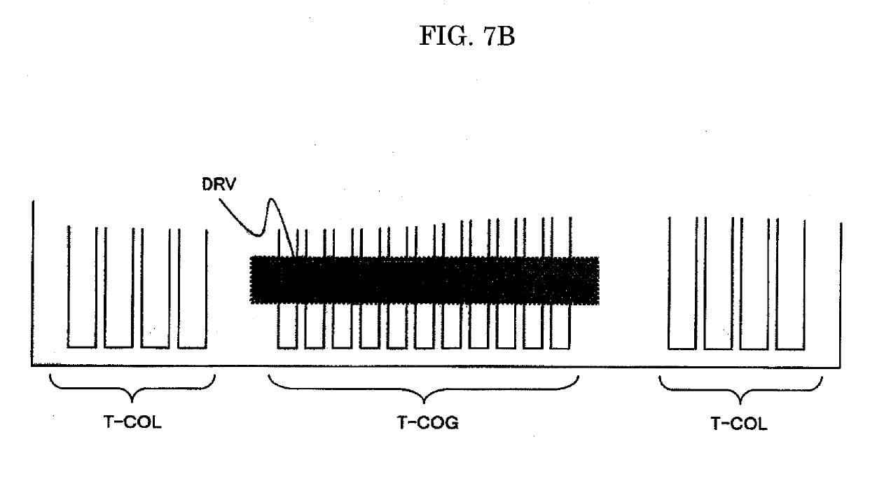

As shown in FIG. 7A, terminals are formed in the peripheral portion of the organic EL display panel. As shown in FIG. 7B showing an enlargement of the circled portion in FIG. 7A, the terminals in the peripheral portion include a terminal group (T-COL) for carrying out inspection in a state where no drive circuit (DRV) is mounted, in addition to a terminal group (T-COG) used after a drive circuit (DRV) is mounted.

Therefore, as shown in FIG. 6B, in the present embodiment, the terminal group (T-COL) for carrying out inspection in a state where no drive circuit (DRV) is mounted includes a terminal (T-CER) through which an aging control signal (S-CER) for R (red) is inputted, a terminal (T-CEG) through which an aging control signal (S-CEG) for G (green) is inputted, a terminal (T-CEB) through which an aging control signal (S-CEB) for B (blue) is inputted, and a terminal (T-SE) through which an aging control switching signal (S-SE) is inputted. In addition, respective signals are supplied to these terminals using a dedicated jig so that optimal aging is carried out for light of each color: R (red), G (green) and B (blue).

In addition, an aging control signal (S-CE) at an L level is outputted from the terminal (T-SE) after a driving circuit (DRV) is mounted, and the first transistor (Q10) is turned off.

Here, in FIGS. 6A and 6B, 20R is an aging control line for R (red), 20G is an aging control line for G (green) and 20B is an aging control line for B (blue). Likewise, 21R is an aging control signal line for R (red), 21G is an aging control signal line for G (green) and 21B is an aging control signal line for B (blue).

### Third Embodiment

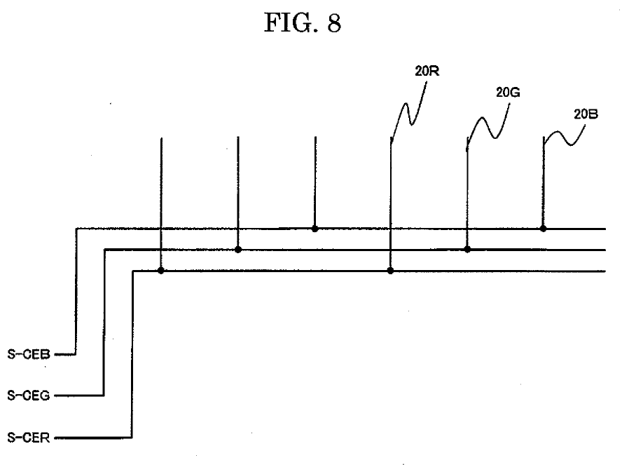

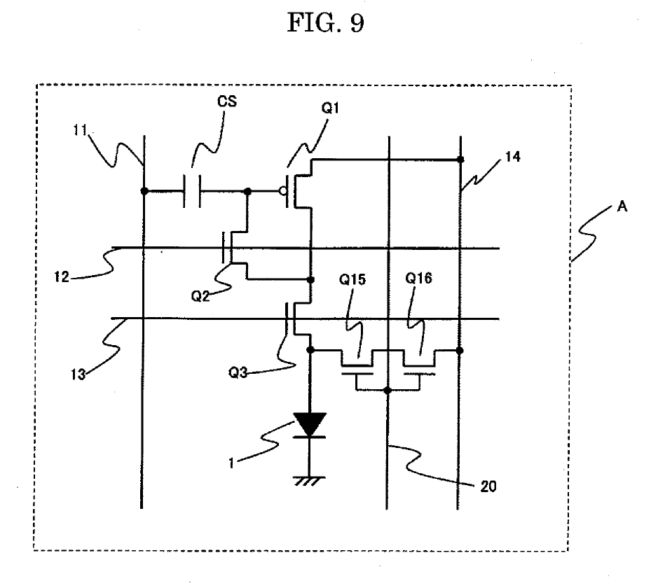

FIG. 8 is a diagram for illustrating the aging method for an organic EL display device according to the third embodiment of the present invention.

FIG. 8 is a wire diagram showing a case where the drive circuit (DRV) outputs an aging control signal after the drive circuit (DRV) is mounted and aging is carried out under optimal aging conditions for light of each color: F (red), G (green) and B (blue).

In the present embodiment, aging is carried out on the basis of the aging control signal outputted from the drive circuit (DRV) after the drive circuit (DRV) is mounted, and therefore, the second transistor (Q11) is not necessary, and thus, the aging control signal switching signal line 22 and the aging control signal lines (21, 21R, 21G, 21B) are not necessary.

Therefore, as shown in FIG. 8, the structure in the peripheral portion is simple, and the drive circuit (DRV) needs to have a function of outputting both an aging control signal at an H level and an aging control signal at an L level as an aging control signal (S-CER) for R (red), an aging control signal (S-CEG) for G (green) and an aging control signal (S-CEB) for B (blue).

Here, in FIG. 8, 20R is an aging control line for R (red), 20G is an aging control line for G (green) and 20B is an aging control line for B (blue).

### Fourth Embodiment

FIG. 9 is a circuit diagram showing the equivalent circuit of one pixel in the organic EL display panel according to the fourth embodiment of the present invention.

In the case where a current is supplied from the power supply line 14 to the organic EL element 1 via the first transistor (Q10) during normal operation, the display quality lowers.

In order to prevent this, it is necessary to reduce the leak current of the aging TFT. In order to do so, it is preferable to use a thin film transistor of an nMOS type, which has little leak current, for the first transistor (Q10). In the present embodiment, two n type thin film transistors Q15 and Q16 are connected in series instead of the first transistor (Q10) so that the leak current is further reduced.

### Fifth Embodiment

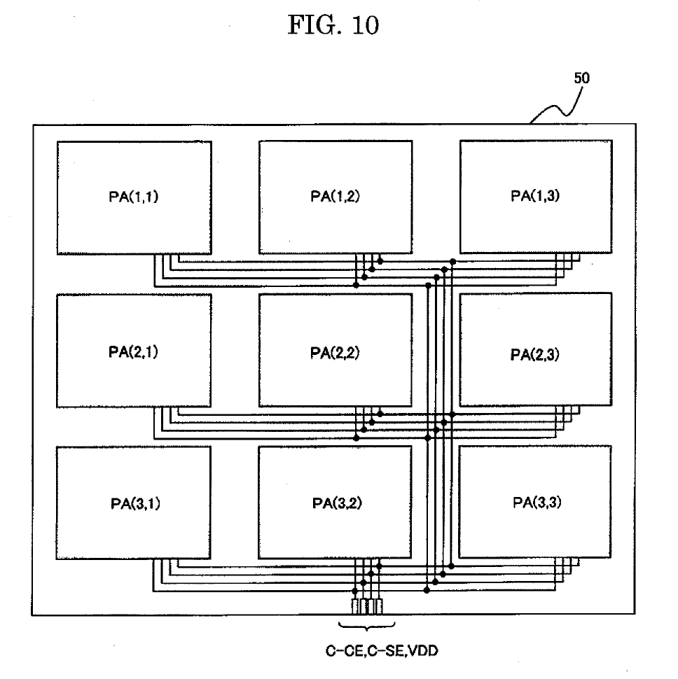

FIG. 10 is a diagram illustrating the aging method for an organic EL display device according to the fifth embodiment of the present invention.

Though aging is usually carried out after a display panel is cut out to an appropriate size, in the present embodiment, as shown in FIG. 10, aging is carried out collectively in a state where a number of display cells PA (1, 1) to PA (3, 3) are formed on the mother substrate 50 before it is cut out to a panel size, where signal wires required for supplying an aging control signal (S-CE), an aging control switching signal (S-Se) and a power supply voltage (VDD) all lead out as terminals formed in the peripheral portion of the mother substrate 50 by supplying an aging control signal (S-CE), an aging control switching signal (S-SE) and a power supply voltage (VDD) using a jig dedicated for these terminals.

In the present embodiment, contact of the needle-like dedicated jig with the terminals is possible at the same time, and therefore, it is possible to increase the work efficiency for aging.

Here, though organic EL display devices having a capacitor direct connection type pixel circuit are described in the above embodiments, the present invention is not limited to these, and can be applied to the capacitor separation type pixel circuit described in the above JP2008-40326A.

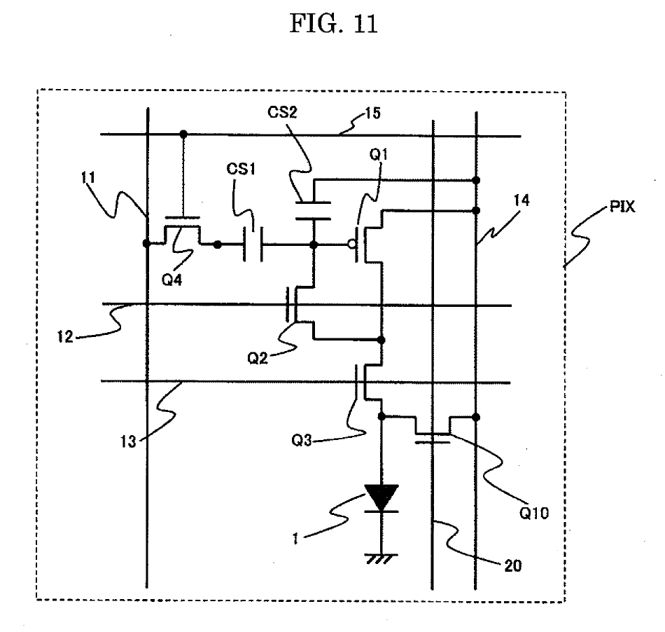

FIG. 11 shows the equivalent circuit of one pixel where the present invention is applied to a capacitor separation type pixel circuit. The circuit shown in FIG. 11 is different from the equivalent circuit shown in FIG. 3 in that an n type thin film transistor Q4 for selecting a display line and capacitor elements for holding a video voltage (CS1, CS2) are provided. Here, the operation of the equivalent circuit shown in FIG. 11 is well known, and therefore the description thereof is omitted.

Though the invention made by the present inventor is concretely described on the basis of the above embodiments, the present invention is not limited to these embodiments, and various modifications are, of course, possible within such a scope as not to deviate from the gist of the present invention.

What is claimed is:

1. A display device, comprising:
a number of pixels;
a drive circuit for supplying a video voltage to each pixel; and
an aging control line, wherein
each pixel has a light emitting element; a drive transistor for driving said light emitting element of which the first electrode is connected to a power supply line; and a first transistor that is connected between said power supply line and said light emitting element so that the gate electrode of said first transistor is connected to said aging control line, wherein
a drive voltage for turning on said first transistor is supplied to said aging control line during aging, and thus a current is supplied to said light emitting element via said first transistor.

2. The display device according to claim 1, wherein
the first electrode has a second transistor that is connected to said aging control line; and an aging control switching signal line that is connected to the gate electrode of said second transistor, wherein
a drive voltage for turning on said second transistor is supplied to said aging control switching signal line and a drive voltage for turning on said first transistor is supplied to the second electrode of said second transistor during aging, and thus, a drive voltage for turning on said first transistor is supplied to said aging control line via said second transistor.

3. The display device according to claim 2, comprising:
a first terminal group that is connected to said drive circuit; and
a second terminal group that is not connected to said drive circuit, wherein
said aging control switching signal line and the second electrode of said second transistor are connected to terminals in said second terminal group.

4. The display device according to claim 2, wherein
said aging control line is connected to said drive circuit, and
said drive circuit supplies a control voltage for turning off said first transistor to said aging control line during normal operation.

5. The display device according to claim 1, wherein
said aging control line is connected to said drive circuit, and
said drive circuit supplies a drive voltage for turning on said first transistor to said aging control line during aging and supplies a control voltage for turning off said first transistor to said aging control line during normal operation.

6. The display device according to claim 1, wherein said first transistor is an n type thin film transistor.

7. The display device according to claim 1, wherein said first transistor is formed of two or more n type thin film transistors that are connected in series.

8. The display device according to claim 1, wherein
said aging control lie is divided into an aging control line for a first color, an aging control line for a second color and an aging control line for a third color,
the gate electrode of said first transistor in a pixel for said first color is connected to said aging control line for a first color,
the gate electrode of said second transistor in a pixel for said second color is connected to said aging control line for a second color, and
the gate electrode of said third transistor in a pixel for said third color is connected to said aging control line for a third color.

9. The display device according to claim 1, further comprising;
a number of signal lines;
a number of reset lines; and
a number of turning on control lines, wherein
each pixel has
a reset transistor that is connected between the control electrode and the second electrode of said drive transistor;
a capacitor element that is connected between the control electrode of said drive transistor and said signal line; and
a turning on transistor that is connected between said light emitting element and said second electrode of said drive transistor, wherein
the gate electrode of said reset transistor is connected to said reset line,
the gate electrode of said turning on transistor is connected to said turning on control line, and
the first electrode of said first transistor is connected to said power supply line and the second electrode connected to the first electrode of said turning on transistor.

10. An aging method for a display device comprising:
a number of pixels;
a drive circuit for supplying a video voltage to each pixel;
an aging control line;
a second transistor of which the first electrode is connected to said aging control line; and
an aging control switching signal line that is connected to the gate electrode of said second transistor, wherein
each pixel has a light emitting element; a drive transistor for driving said light emitting element of which the first electrode is connected to a power supply line; and a first transistor that is connected between said power supply line and said light emitting element, and
the gate electrode of said first transistor is connected to said aging control line, wherein
a drive voltage for turning on said second transistor is supplied to said aging control switching signal line and a drive voltage for turning on said first transistor is supplied to the second electrode of said second transistor during aging so that a drive voltage for turning on said first transistor is supplied to said aging control line via said second transistor, and thus, a current is supplied to said light emitting element via said first transistor.

11. The aging method according to claim 10, further comprising:
a first terminal group that is connected to said drive circuit; and
a second terminal group that is not connected to said drive circuit, wherein
said aging control switching signal line and the second electrode of said second transistor are connected to terminals in said second terminal group, wherein
a drive voltage for turning on said second transistor is supplied to the terminal connected to said aging control switching signal line and a drive voltage for turning on said first transistor is supplied to the terminal connected to the second electrode of said second transistor using a dedicated jig during aging.

12. An aging method for display cells, wherein
a number of display cells are formed on a mother substrate,
each display cell comprises a number of pixels; a drive circuit for supplying a video voltage to each pixel; an aging control line; a second transistor of which the first electrode is connected to said aging control line; and an aging control switching signal line that is connected to the gate electrode of said second transistor,
each pixel has a light emitting element; a drive transistor for driving said light emitting element of which the first electrode is connected to a power supply line;
and a first transistor that is connected between said power supply line and said light emitting element, and the gate electrode of said first transistor is connected to said aging control line, wherein
said aging control switching signal line of said display cell, the second electrode of said second transistor and said power supply line are connected to terminals formed on said mother substrate, and
a drive voltage for turning on said second transistor is supplied to the terminal on said mother substrate connected to said aging control switching signal line of said display cell, a drive voltage for turning on said first transistor is supplied to the terminal on said mother substrate connected to the second electrode of said second transistor of said display cell, and a power supply voltage is supplied to the terminal on said mother substrate connected to said power supply line of said display cell.

13. The aging method according to claim 10, wherein
said aging control lie is divided into an aging control line for a first color, an aging control line for a second color and an aging control line for a third color,
the gate electrode of said first transistor in a pixel for said first color is connected to said aging control line for a first color,
the gate electrode of said second transistor in a pixel for said second color is connected to said aging control line for a second color,
the gate electrode of said third transistor in a pixel for said third color is connected to said aging control line for a third color, and,
pixels for said first color, pixels for said second color and pixels for said third color have different aging periods.
